(19) United States
(12) Patent Application Publication
(10) Pub. No.: US 2016/0188706 A1
(43) Pub. Date: Jun. 30, 2016

(54) SYSTEM, SERVER, AND ELECTRONIC DEVICE

(71) Applicant: KABUSHIKI KAISHA TOSHIBA, Tokyo (JP)

(72) Inventors: Kohei MOMOSAKI, Mitaka Tokyo (JP); Tetsuo HATAKEYAMA, Tachikawa Tokyo (JP); Atsushi MATSUNO, Ome Tokyo (JP)

(21) Appl. No.: 14/858,870

(22) Filed: Sep. 18, 2015

(30) Foreign Application Priority Data
Dec. 25, 2014 (JP) 2014-262321

(51) Int. Cl. G06F 17/30; G10L 15/22; G06F 3/16

(52) U.S. Cl. CPC G06F 17/30684; G06F 3/167; G10L 15/22; G06F 17/30696; G06F 17/30864

(57) ABSTRACT

According to one embodiment, a system includes a first server, a second server, and an electronic device, all being communicably connected to one another.

### CROSS-REFERENCE TO RELATED APPLICATIONS

This application is based upon and claims the benefit of priority from Japanese Patent Application No. 2014-262321, filed Dec. 25, 2014, the entire contents of which are incorporated herein by reference.

### FIELD

Embodiments described herein relate generally to a system, a server, and an electronic device.

### BACKGROUND

In recent years, net shopping has been widely spread. With the spread of net shopping, searching for merchandise using speech recognition technology has been proposed in order to allow users who are not familiar with computers to also enjoy net shopping.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 illustrates the structure of a net shopping system in an embodiment.

FIG. 2 illustrates the data structure of a merchandise database in the embodiment.

FIG. 3 illustrates the data structure of a list of aliases in the embodiment.

FIG. 4 illustrates the data structure of a word-pronunciation connecting list in the embodiment.

FIG. 5 illustrates the structure of the electronic device in the embodiment.

FIG. 6 illustrates the functional structure of a net shopping application in the embodiment.

FIG. 7 is a flow chart illustrating the processing procedure of a net shopping application in the embodiment for enjoying net shopping.

FIG. 8 illustrates an example of an initial screen.

FIG. 9 illustrates an example of a voice input screen.

FIG. 10 illustrates an example of a search-word display screen.

FIG. 11 illustrates an example of a search-results screen.

FIG. 12 illustrates the data structure of another alias list in the embodiment.

FIG. 13 illustrates the data structure of another word-pronunciation connecting list in the embodiment.

FIG. 14 is a flow chart illustrating the alias list generation processing procedure in another embodiment.

### DETAILED DESCRIPTION

Various embodiments will be described hereinafter with reference to the accompanying drawings.

In general, according to one embodiment, a system includes a first server, a second server, and an electronic device communicably connected to one another. The first server includes a first storage storing a database containing at least a plurality of names, and a second storage storing a first list comprising a plurality of notations of words, each of which is associated with at least one additional notation. The second server includes a third storage storing a second list generated based on the database and the first list, the second list associating the plurality of notations of words of the first list with a corresponding pronunciation. The electronic device includes one or more processor. The processor is configured to receive voice data. The processor is configured to identify a notation in the second list associated with a pronunciation obtained as a result of recognition processing applied to the received voice data. The processor is configured to present a user with the identified notation as a search word. The processor is configured to search the database for a first name including the presented search word. The processor is configured to present the user with the search result.

### First Embodiment

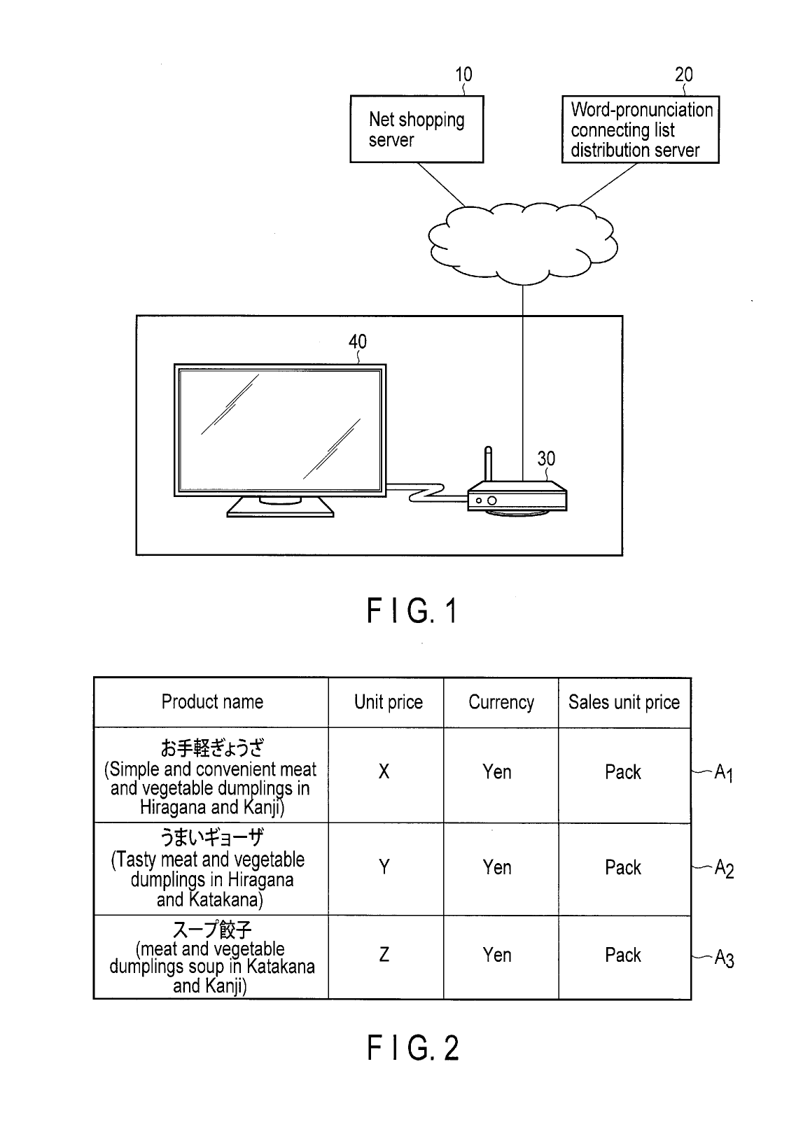

FIG. 1 illustrates the structure of a net shopping system in any embodiment.

The net shopping system includes a net shopping server 10, a word-pronunciation connecting list distribution server 20, an electronic device 30, a display 40, etc., as illustrated in FIG. 1.

The net shopping server 10 is a server having a function of holding a merchandise database, which keeps a list of merchandise, and an alias list, which is consulted at the time of merchandise search processing, and a function of distributing the database and the list to the electronic device 30.

The word-pronunciation connecting list distribution server 20 is a server having a function of holding a word-pronunciation connecting list, which is consulted at the time of speech recognition processing, and a function of distributing the word-pronunciation connecting list to the electronic device 30.

The electronic device 30 is a device having a box-shaped case, as illustrated in FIG. 1, and is exclusively used for net shopping. It should be noted here that the electronic device 30 may be realized by, instead of the above-mentioned exclusive device, a tablet computer, a notebook computer, a smartphone, or the like, in which an application having the same functions as those of the device exclusively used for net shopping is installed. In the following explanation, the electronic device 30 will be simply written as “computer 30.”

The display 40 is a television set or a display monitor, for example, and is a device which displays on a screen the variety of information output from the computer 30.

Now, a merchandise database will be explained with reference to FIG. 2. FIG. 2 illustrates an example of the data structure of a merchandise database. The merchandise database stores the merchandise information in which a product name, a unit price, currency, and a sales unit are registered for all merchandise, as illustrated in FIG. 2. The product name indicates the name of merchandise obtained as a result of merchandise search processing. The unit price indicates a price of one item of merchandise which is connected with the product name. Currency indicates the unit of the currency which is used in purchasing merchandise connected with the product name. The sales unit indicates the sales unit of the merchandise connected with the product name. For example, merchandise information Aₗ illustrated in FIG. 2 indicates that the name of merchandise is “ [symbol] [symbol] ” (Simple and convenient meat and vegetable dumplings, in which/gyōza/is written in Hiragana), and the “unit price” per “pack” of these “simple and convenient meat and vegetable dumplings” is “X yen.” Merchandise information A₁ has been explained here by way of example. The same thing can be said of the remaining items of merchandise information A₂ and A₃. Therefore, their detailed explanation will be omitted here. Moreover, the case where the merchandise information stored in a merchandise database has such a data structure as illustrated in FIG. 2 has been explained here. However, the merchandise information may further contain, for example, a merchandise identification number for identifying an item of merchandise information, etc.

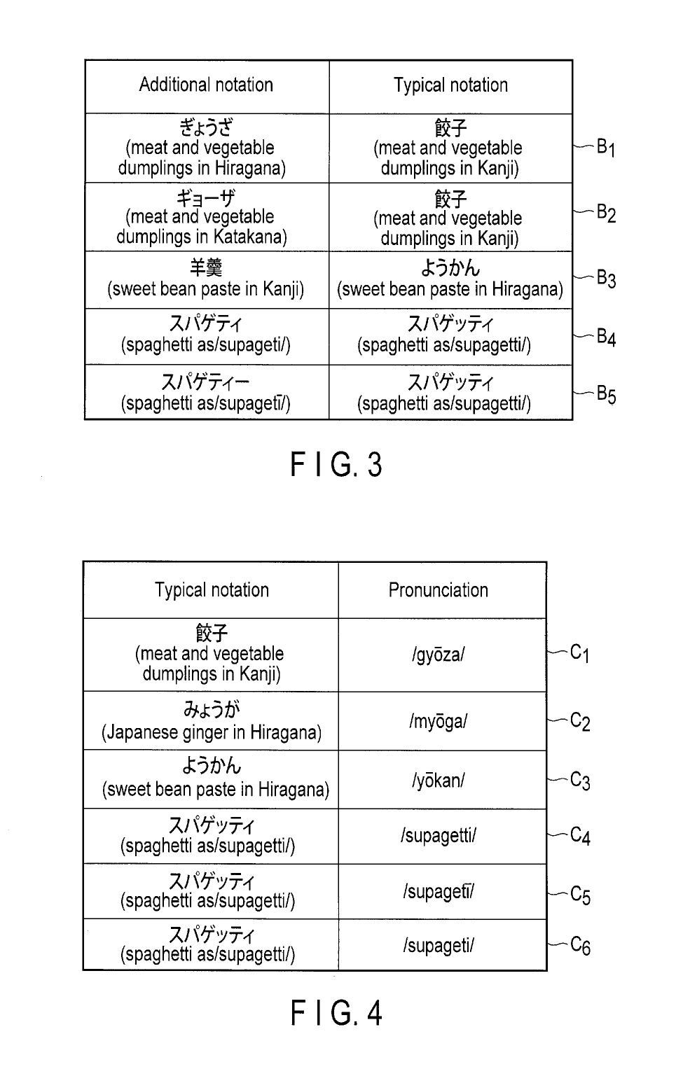

Next, an alias list will be explained with reference to FIG. 3. FIG. 3 illustrates an example of the data structure of an alias list. The alias list stores a series of words to indicate word by word a connection between a typical notation of a word and at least one additional notation (alias) of the word, as illustrated in FIG. 3. A typical notation is a notation of a predetermined word and is displayed on the display 40 as a search word. An alias or additional notation is different from a typical notation to which it is connected. However, the additional notation is a notation of a word which is equivalent in both pronunciation and meaning to a word which is written by the typical notation, or the additional notation is a notation of a word which is equivalent in meaning but is similar in pronunciation to a word which is written by the typical notation. For example, B₁ and B₂ illustrated in FIG. 3 indicate that a typical notation “ [symbol] ” (/gyōza/, meaning “meat and vegetable dumplings”, in Kanji) can be differently written as “ [symbol] ” (/gyōza/, meaning “meat and vegetable dumplings”, in Hiragana) or “ [symbol] ” (/gyōza/, meaning “meat and vegetable dumplings”, in Katakana). It should be noted that “ [symbol] ” (in Hiragana) and “ [symbol] ” (in Katakana) are individually equivalent in both pronunciation and meaning to “ [symbol] [symbol] ” (in Kanji) with which they are connected, and all of these three notations represents the same merchandise. Let us cite another example; B₄ and B₅ illustrated in FIG. 3 indicate that a typical notation “ [symbol] ” (/supagetti/, meaning “spaghetti”, in Katakana) can be differently written as “ [symbol] ” (/supageti/, meaning “spaghetti”, in Katakana) and “ [symbol] ” (/supageti/, meaning “spaghetti”, in Katakana). It should be noted that “ [symbol] ” (/supageti/, in Katakana) and “ [symbol] ” (/supageti/, in Katakana) are individually equivalent in meaning and similar in pronunciation to “ [symbol] ” (/supagetti/, in Katakana) with which they are connected, and all of these three notations represents the same merchandise “spaghetti.” The same thing may be said of B₃ illustrated in FIG. 3. Therefore, the detailed explanation of B₃ will be omitted here.

By consulting the above-mentioned alias list while the search for merchandise is being executed with the use of a typical notation displayed on the display 40 as a search word, an extra search using different notations connected with the typical notation can also be executed in addition to the search using the typical notation at a single merchandise search operation. For example, “ [symbol] ” (/sūpu gyōza/, meaning “meat and vegetable dumpling soup”, in Katakana and Kanji) may be found with the use of the typical notation “ [symbol] ” (in Kanji), and “ [symbol] ” (/otegaru gyōza/, meaning “simple and convenient meat and vegetable dumplings”, in Hiragana and Kanji) and “ [symbol] ” (/umai gyōza/, meaning “tasty meat and vegetable dumplings”, in Hiragana and Katakana) may be found with the use of the additional notations “ [symbol] ” (in Hiragana) and “ [symbol] [symbol] ,” (in Katakana) both being related to the typical notation.

Next, a word-pronunciation connecting list will be explained with reference to FIG. 4. FIG. 4 i illustrates an example of the data structure of a word-pronunciation connecting list. A word-pronunciation connecting list is a list generated with reference to the merchandise database and the alias list, both of which are held at the net shopping server 10, and preserves the connection between typical notations and their respective pronunciations, as illustrated in FIG. 4. Since the typical notation has already been explained above, the details of the typical notation are omitted here. Pronunciation here is a pronunciation, which is registered as the reference of comparison and with which an input speech sound will be compared in speech recognition processing, and represents a presumable pronunciation presumed to be obtained as a result of speech recognition processing. For example, C₁ illustrated in FIG. 4 indicates that, when the pronunciation “/gyōza/” is obtained as a result of speech recognition processing, “ [symbol] ” (in Kanji) will be displayed on the display 40 as a search word (a typical notation). Similarly, C₂ illustrated in FIG. 4 indicates that, when the pronunciation “/myōga/” is obtained as a result of speech recognition processing, “ [symbol] ” (Japanese ginger in Hiragana) will be displayed on the display 40 as a search word (a typical notation). Moreover, C₄-C₆ illustrated in FIG. 4 indicate that, when any one of the pronunciations “/supagetti/” and “/supageti/” is obtained as a result of speech recognition processing, “ [symbol] ” (spaghetti, in Katakana) will be displayed on the display 40 as a search word (a typical notation). It should be noted that C₁, C₂, and C₄-C₆ have been explained by way of example, but that the same thing can be said of C₃. Therefore, the detailed explanation of C₃ will be omitted here.

The above-mentioned word-pronunciation connecting list makes it possible to reduce useless presentation to a user of various search words having been obtained as a result of speech recognition processing. For example, when the pronunciation “/gyōza/” is obtained as a result of speech recognition processing, the word (or the typical notation) “ [symbol] ” (in Kanji) alone will be presented without presenting useless words “ [symbol] ” (in Hiragana) and “ [symbol] ”(in Katakana) as additional search words.

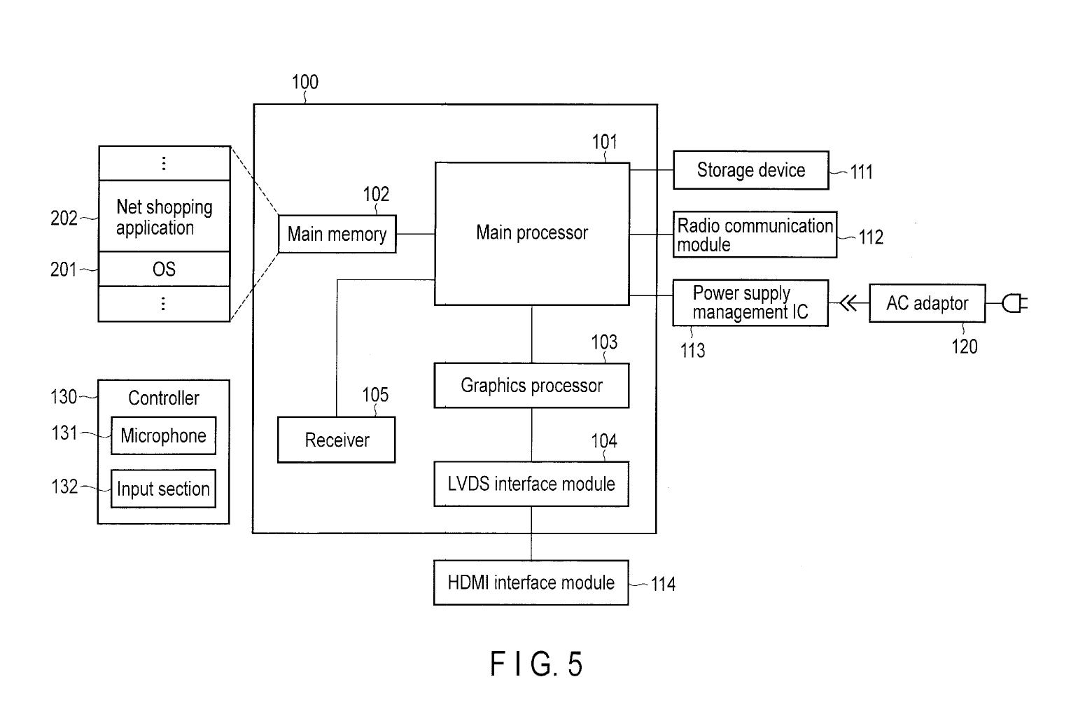

FIG. 5 illustrates the system structure of the computer 30 in the first embodiment.

The computer 30 includes a processor 100, a storage device 111, a radio communication module 112, a power supply management IC 113, an HDMI (registered trademark) interface module 114, etc., as illustrated in FIG. 5.

The storage device 111 is a recording device which has a nonvolatile memory, a flash memory, a magnetoresistive memory, a hard disk drive, etc.

The radio communication module 112 communicates with servers connected to a network, including the net shopping server 10 and the word-pronunciation connecting list distribution server 20.

The power supply management IC 113 is a single-chip microcomputer for power supply management. Moreover, the power supply management IC 113 generates operating electric power, which should be supplied to each component, using the electric power supplied from an AC adaptor 120.

The HDMI interface module 114 changes a signal suitable for later mentioned low-voltage differential signaling (LVDS) into a signal suitable for High-Definition Multimedia Interface (HDMI).

The processor 100 includes a main processor 101, a main memory 102, a graphics processor 103, an LVDS interface module 104, a receiver 105, etc.

The main processor 101 controls the operation of various modules in the computer 30. The computer 30 executes various programs loaded from the storage device 111 into the main memory 102. The programs which the processor executes include an operating system (OS) 201 and various application programs, in which a net shopping application 202 is included. The net shopping application 202 is a program for enjoying net shopping.

The graphics processor 103 is a display controller which controls the display 40 used as a display monitor. The graphics processor 103 generates picture image data for displaying an image on the display 40. The LVDS interface module 104 changes the picture image data into a signal suitable for low voltage differential signaling (LVDS).

The receiver 105 has functions of receiving voice data, which is input from a microphone 131 in the controller 130, and outputting the received voice data to the main processor 101. Moreover, the receiver 105 has functions of receiving an input signal, which is input from and corresponds to any one of predetermined input keys arranged at an input section 132 in the controller 130, and outputting the received input signal to the main processor 101.

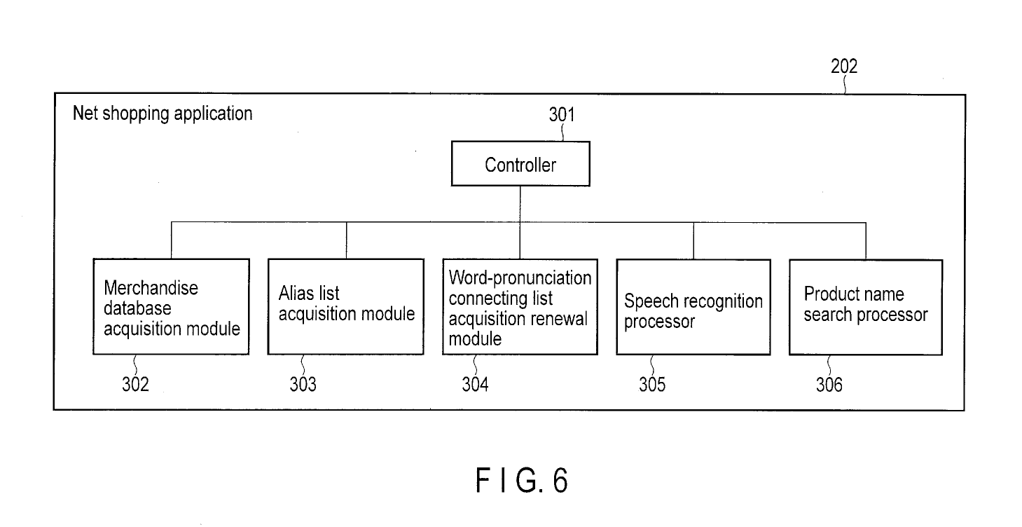

FIG. 6 is a Block diagram illustrating the functional structure of the net shopping application 202 illustrated in FIG. 5.

The net shopping application 202 includes a controller 301, a merchandise database acquisition module 302, an alias list acquisition module 303, a word-pronunciation connecting list acquisition renewal module 304, a speech recognition processor 305, a product name search processor 306, etc., as illustrated in FIG. 6.

The controller 301 controls the operation of the net shopping application 202.

The merchandise database acquisition module 302 acquires from the net shopping server 10 using the radio communication module 112 a merchandise database which shows a list of merchandise currently dealt with in the net shopping server 10, as illustrated in FIG. 2. In this connection, the merchandise database acquired by the merchandise database acquisition module 302 will be stored in the storage device 111 by the controller 301 as occasion arises.

The alias list acquisition module 303 acquires an alias list, such as illustrated in FIG. 3, from the net shopping server 10 using the radio communication module 112. In this connection, the alias list acquired by the alias list acquisition module 303 will be stored in the storage device 111 by the controller 301 as occasion arises.

The word-pronunciation connecting list acquisition renewal module 304 acquires a word-pronunciation connecting list, such as illustrated in FIG. 4, using the radio communication module 112 from the word-pronunciation connecting list distribution server 20, and, when the word-pronunciation connecting list is already stored in the storage device 111, updates the stored word-pronunciation connecting list using the newly acquired word-pronunciation connecting list. In contrast, when a word-pronunciation connecting list is acquired from the word-pronunciation connecting list distribution server 20 and the word-pronunciation connecting list is not stored in the storage device 111, the acquired word-pronunciation connecting list will be stored in the storage device 111 by the controller 301 as occasion arises.

The speech recognition processor 305 performs speech recognition processing on voice data which is input from the microphone 131 arranged in the controller 130 and is received by the receiver 105. Specifically, the speech recognition processor 305 analyzes the voice data and generates a text from the voice data. Moreover, the speech recognition processor 305 finds out a typical notation of the word (pronunciation), which has been obtained by generating the text from the voice data, with reference to the word-pronunciation connecting list stored in the storage device 111 and displays the found out typical notation as a search word on the display 40.

When one search word is selected by the user from one or more search words displayed on the display 40, the product name search processor 306 executes merchandise search processing using the selected search word and the alias list stored in the storage device 111 and searches the merchandise database stored in the storage device 111 for merchandise information. The merchandise information acquired as a result of this search is displayed on the display 40.

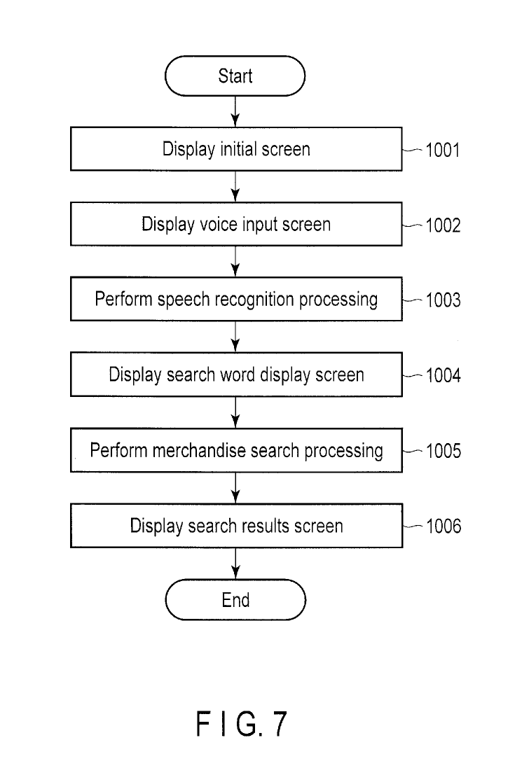

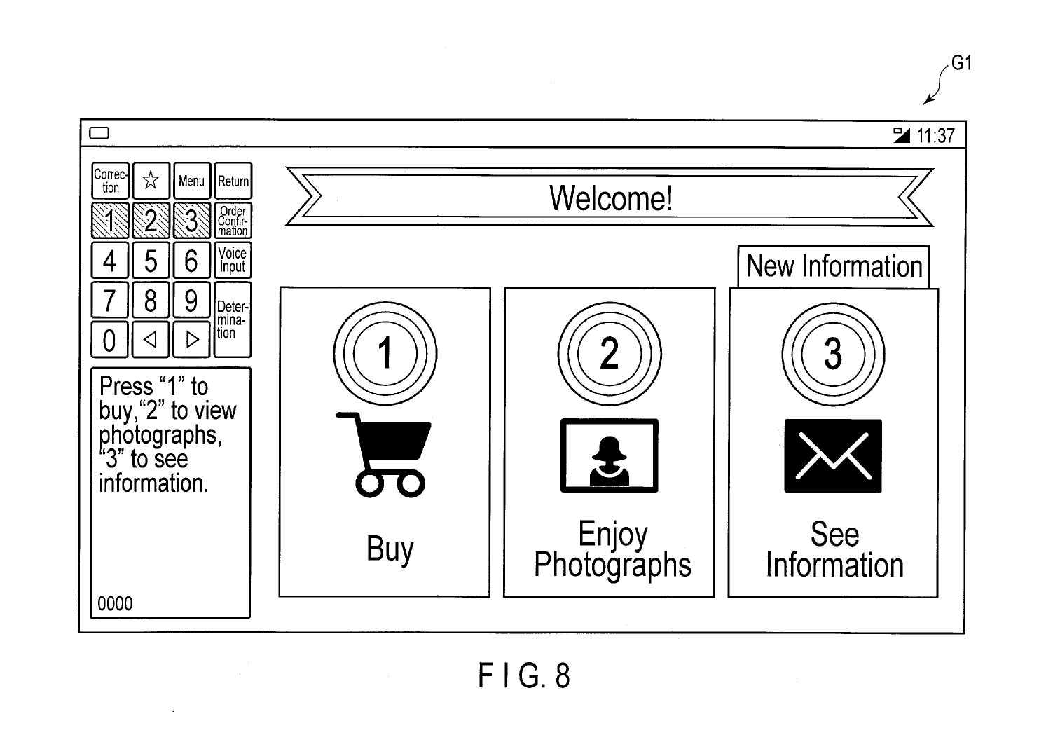

Next, the processing procedure, which the net shopping application 202 configured as mentioned above executes at the time of net shopping, will be explained below with reference to the flow chart illustrated in FIG. 7 and the exemplified screens illustrated in FIG. 8 to FIG. 11. It should be noted that a case where various items of information such as illustrated in FIG. 2 to FIG. 4 are already stored in the storage device 111 is assumed here.

First of all, the net shopping application 202 is made to start by a user's operation. Then, the net shopping application 202 causes the display 40 to display an initial screen G1 illustrated in FIG. 8 (Block 1001).

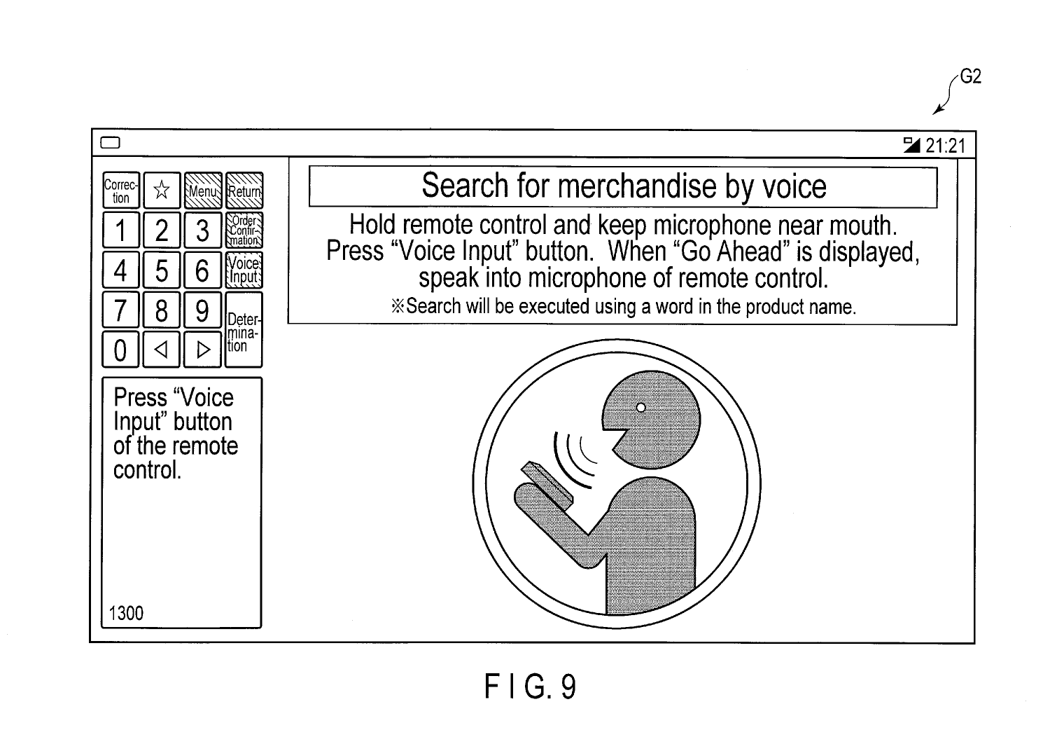

Then, the net shopping application 202 causes the display 40 to display an voice input screen G2 illustrated in FIG. 9, when it receives an input signal from an input key which is indicative of “1”. and is selected from the input keys arranged at the input section 132 in the controller 130 (Block 1002). Although any illustration is not presented, the net shopping application 202 causes the display 40 to display a screen corresponding to “See Photographs” when it receives an input signal from an input key which is indicative of “2.” Moreover, the net shopping application 202 causes the display 40 to display a screen corresponding to “See Information” when it receives an input signal from an input key which is indicative of “3.”

When the net shopping application 202 receives voice data having been input through the microphone 131 in the controller 130, it performs speech recognition processing to the voice data (Block 1003). Let us suppose that a user says “ [symbol] ” (/gyōza/, meaning “meat and vegetable dumplings”, in Hiragana). That is, the following explanation will be given on the assumption that the net shopping application 202 should obtain the word (pronunciation) “ [symbol] ” (/gyōza/, meaning “meat and vegetable dumplings”, in Hiragana) as a result of the above-mentioned speech recognition processing.

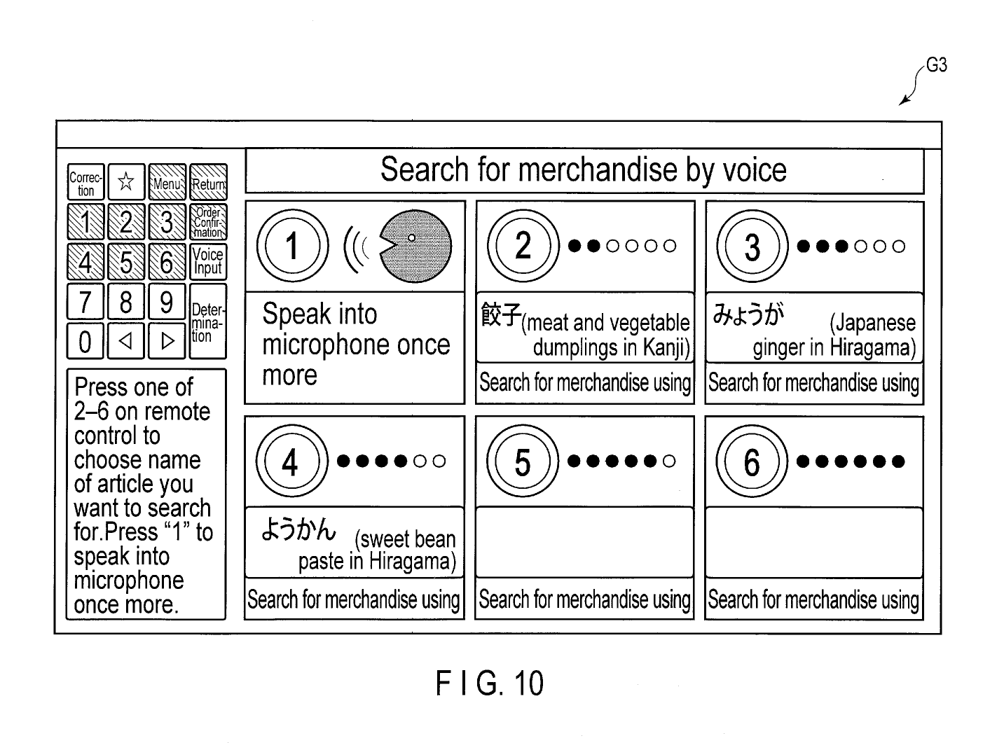

Then, the net shopping application 202 reads from the word-pronunciation connecting list, which is illustrated in FIG. 4 and stored in the storage device 111, at least “ [symbol] ” (meaning “meat and vegetable dumplings”)as a typical notation (in Kanji) related to the word (pronunciation) “ [symbol] ” (meaning “meat and vegetable dumplings”, in Hiragana) obtained by the processing of Block 1003 and causes the display 40 to display the word “ [symbol] ” (meaning “meat and vegetable dumplings”, in Kanji) as a search word. It is assumed here that “ [symbol] ” (/myōga/, meaning “Japanese ginger”, in Hiragana) and “ [symbol] ” (/yōkan/, meaning “sweet bean paste”, in Hiragana) are also read from a word-pronunciation connecting list as other typical notations that are similar in pronunciation to the word (pronunciation) “ [symbol] ” (/gyōza/, meaning “meat and vegetable dumplings”, in Hiragana), and are displayed on the display 40 as further search words. Namely, the net shopping application 202 causes the display 40 to display a search-word display screen G3 such as illustrated in FIG. 10 (Block 1004).

Next, the net shopping application 202 performs merchandise search processing using the word “ [symbol] ” (meaning “meat and vegetable dumplings”, in Kanji) as a search word, when it receives an input signal from an input key which is indicative of “2” and is selected from the input keys arranged at the input section 132 in the controller 130 (Block 1005). Specifically, the net shopping application 202 first reads the words “ [symbol] ” (meaning “meat and vegetable dumplings”, in Hiragana) and “ [symbol] ”(meaning “meat and vegetable dumplings”, in Katakana) as the additional notations related to the word (typical notation) “ [symbol] ” (meaning “meat and vegetable dumplings”, in Kanji) from the alias list illustrated in FIG. 3 and stored in the storage device 111. Then, the net shopping application 202 reads all items of merchandise information, each item having a product name containing at least one of the words “ [symbol] ,” (in Kanji) “ [symbol] ,” (in Hiragana) and “ [symbol] ,” (in Katakana) from the merchandise database illustrated in FIG. 2 and stored in the storage device 111. In this case, the net shopping application 202 acquires three items of merchandise information A1-A3 as a result of the merchandise search processing.

It should be noted that, when an input signal corresponding to an input key indicative of “1” is input by the user while the search-word display screen G3 is being displayed (in other words, when a search word desirable for the user is not displayed on the search-word display screen G3), it returns to processing of Block 1002 and the voice input screen G2 is displayed on the display 40 again.

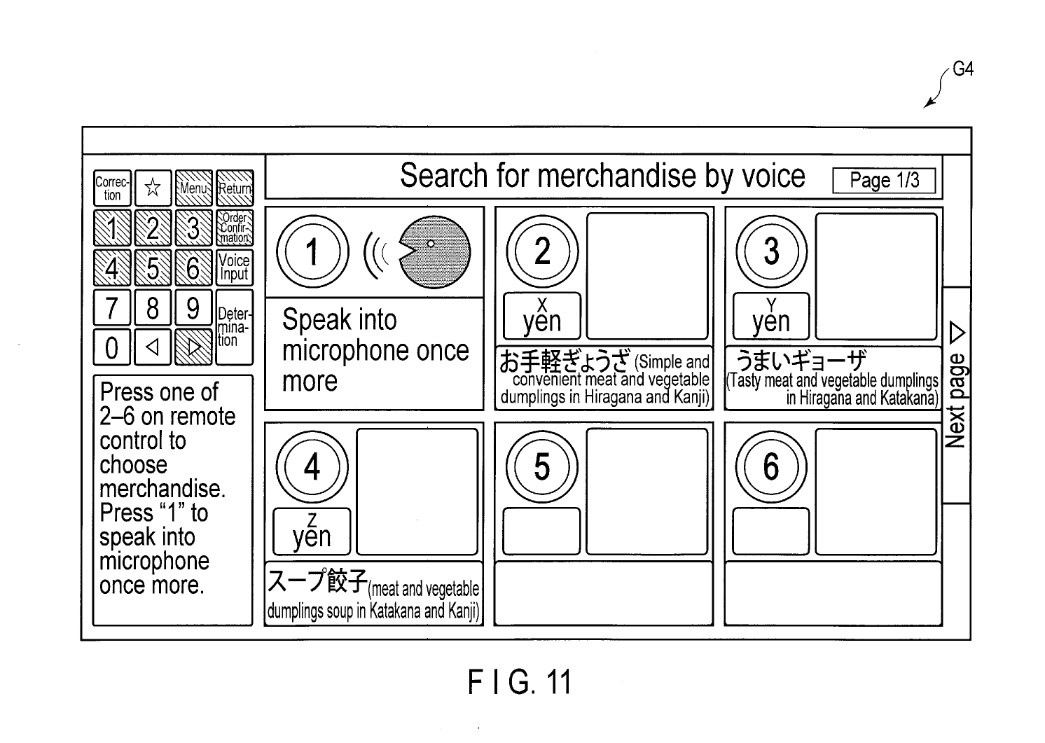

After that, the net shopping application 202 causes the display 40 to display as a result of merchandise search processing the items of merchandise information A1-A3 acquired by the process of the Block 1005. Namely, the net shopping application 202 causes the display 40 to display the search-results screen G4 such as illustrated in FIG. 11 (Block 1006).

When desired merchandise is chosen by the user, a settlement screen for purchasing the merchandise will be displayed on the display 40. When the settlement of an account is completed using the settlement screen, a series of actions required for net-shopping by the net shopping application 202 will be terminated.

The first embodiment having been explained above is configured to perform speech recognition processing using a word-pronunciation connecting list, and thus makes it possible to present a user with only a typical notation of a word (pronunciation) obtained by converting voice data into text. Moreover, even if only a single typical notation of a predetermined word (pronunciation) is presented to a user as a search word, it will be possible to perform a comprehensive search using both the typical notation and additional notations related to the typical notation, so long as a word-pronunciation connecting list is connected with an alias list.

Although a case in which the computer 30 performs merchandise search processing has been presented to explain the present embodiment, it is possible that the net shopping server 10 performs merchandise search processing. In this case, it is necessary for the computer 30 to output to the net shopping server 10 an item of information indicative of a typical notation related to a word (pronunciation) obtained as a result of speech recognition processing, but the processing load imposed on the computer 30 will be greatly reduced, since the computer 30 is not required to perform merchandise search processing. Moreover, since the net shopping server 10 performs merchandise search processing, the storage device 111 of the computer 30 is only required to store at most a word pronunciation connecting list, but the storage device 111 is not required to further keep a merchandise database and an alias list.

In the present embodiment, the speech recognition processor 305 converts voice data into text with reference to a word-pronunciation connecting list, and outputs a typical notation of a word (pronunciation) obtained by the conversion of the voice data into the text. Instead, however, it is possible that the speech recognition processor 305 is configured to perform collation of voice data using a word-pronunciation connecting list, with which a pronunciation of each word is registered in advance, and to output as a result of the collation both a pronunciation and a typical notation of a word registered in the list.

It should be remembered that the computer 30 has been supposed to perform speech recognition processing in the above explanation of the present embodiment. However, it is possible that the net shopping server 10 or any other server, which is not illustrated in the drawings, performs speech recognition processing. In such cases, the computer 30 needs to send voice data to a server and to acquire from the server a speech recognition result, but the computer 30 does not need to perform speech recognition processing. Therefore, the processing load imposed on the computer 30 will be greatly reduced. Moreover, when the server performs speech recognition processing, it is the server that must have a word-pronunciation connecting list. Therefore, there is no need to distribute the word-pronunciation connecting list to the computer 30 from the word-pronunciation connecting list distribution server 20. That is, the word-pronunciation connecting list may not be stored in the storage device 111 of the computer 30.

Moreover, in the above explanation of the present embodiment, the product name search processor 306 is supposed to perform merchandise search processing after one search word has been chosen by the user from those displayed on the display 40. Instead, however, it is possible that the display 40 displays one search word alone and the product name search processor 306 performs merchandise search processing without requiring selection by a user.

In the above explanation of the present embodiment, a merchandise database, an alias list, and a word-pronunciation connecting list are supposed to be prepared in Japanese, but it is possible to prepare them in English, for instance. An exemplary data structure for an alias list and a word-pronunciation connecting list, both being prepared in English, will be explained below.

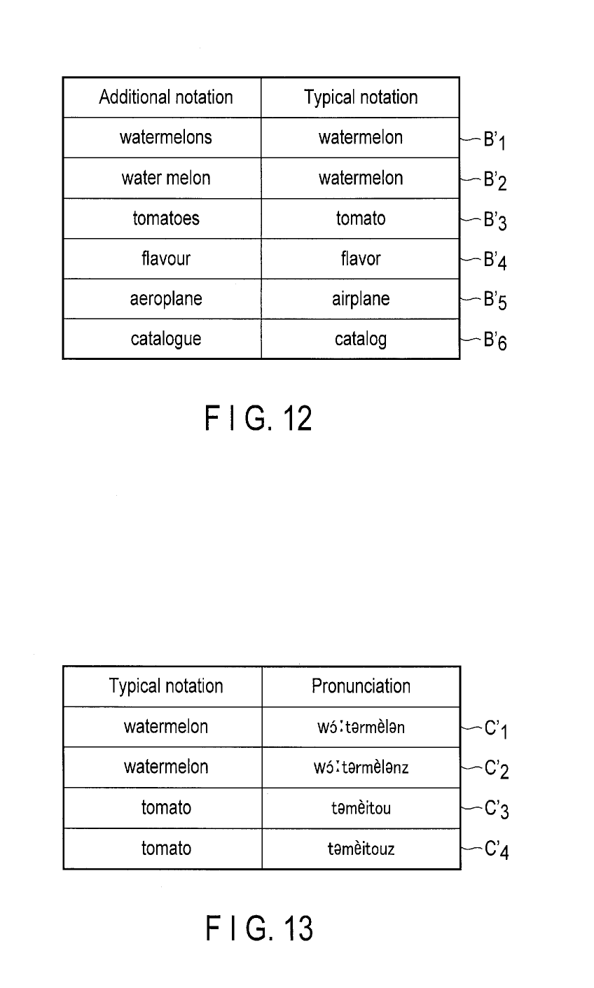

FIG. 12 illustrates an exemplary data structure of an alias list, which is different from the data structure of the alias list illustrated in FIG. 3. B′₁ and B′₂ illustrated in FIG. 12 indicate that a typical notation “watermelon” has as its additional notations “watermelons” (plural form) and “water melon” (notation containing a space). Moreover, B′₄ indicates that a typical notation “flavor” has an alias “flavour,” which is equivalent in pronunciation and meaning but different in spelling. B′₅ indicates that a typical notation “airplane” has an alias “aeroplane,” which is equivalent in meaning and similar in pronunciation. It should be noted that B′₁, B′₂, B′₄, and B′₅ have been explained by way of example, but that the same thing can be said of B′₃ and B′₆. Therefore, the detailed explanation of B′₃ and B′₆ will be omitted here.

FIG. 13 illustrates an exemplary data structure of another word-pronunciation connecting list different from what is illustrated in FIG. 4. C′₁ illustrated in FIG. 13 indicates that the display 40 displays “watermelon” as a search word (a typical notation) when the pronunciation “wo:t [symbol] rmel [symbol] n” is obtained as a result of speech recognition processing. Moreover, C′₂ illustrated in FIG. 13 indicates that the display 40 displays “watermelon” as a search word (a typical notation) when the pronunciation “wo:t [symbol] rmel [symbol] nz” is obtained as a result of speech recognition processing. It should be noted that C′₁ and C′₂ have been explained by way of example, but that the same thing can be said of C′₃ and C′₄. Therefore, the detailed explanation of C′₃ and C′₄ will be omitted here.

As has been explained above, even if the alias list and the word-pronunciation connecting list are prepared in English, the effect similar to the above-mentioned effect can be obtained.

### Second Embodiment

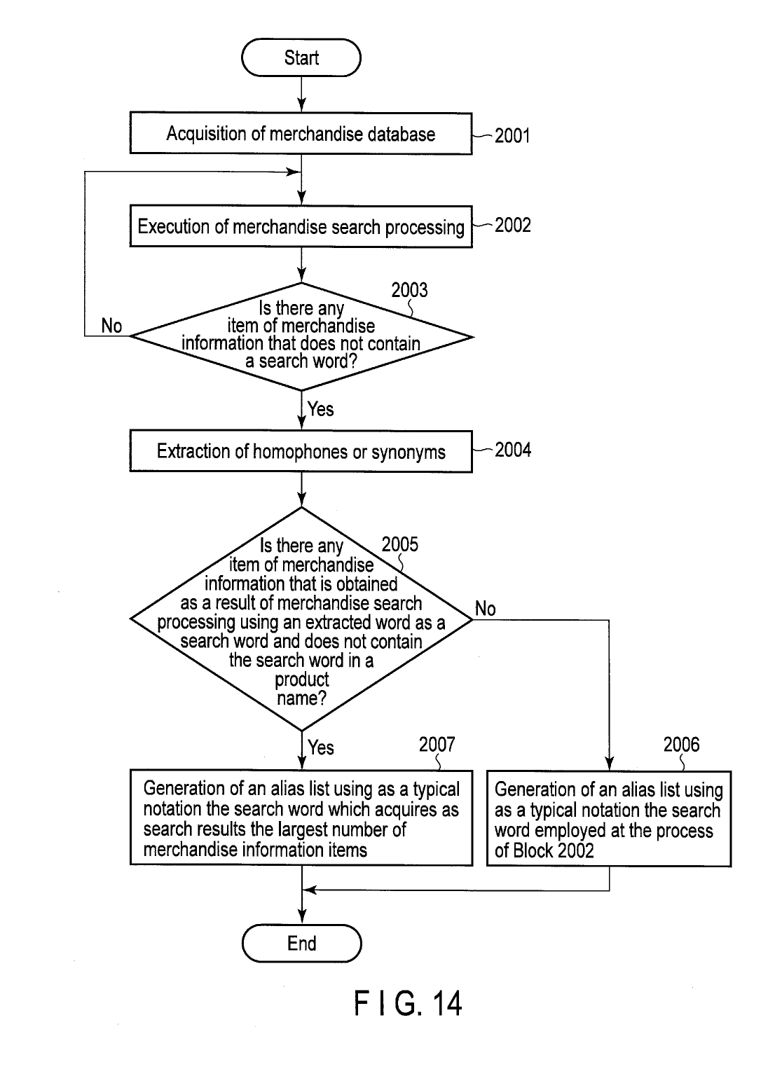

Now, a second embodiment will be explained below. What follows is an explanation of a series of acts which the second embodiment executes when the net shopping server 10 does not hold an alias list or when an alias list cannot be obtained from the net shopping server 10. In such a case the following inconvenience may occur: the word-pronunciation connecting list distribution server 20 cannot create a word-pronunciation connecting list, and by extension a series of acts which the first embodiment does at the time of the net shopping cannot be executed in the second embodiment. For this reason, the word-pronunciation connecting list distribution server 20 performs alias list generation processing to generate an alias list. The procedure for generating the alias list will be specifically explained below with reference to the flow chart of FIG. 14.

First of all, the word-pronunciation connecting list distribution server 20 acquires a merchandise database from the net shopping server 10 (Block 2001). Then, the word-pronunciation connecting list distribution server 20 performs the merchandise search processing with reference to a search word list prepared beforehand (Block 2002). The search word list is a list of numerous words, each of which can be a search word. Let us suppose that the process of Block 2002 is performed using a word “ [symbol] ” (meaning “meat and vegetable dumplings”, in Kanji) as a search word by way of example.

Now, the word-pronunciation connecting list distribution server 20 determines whether or not merchandise information acquired as a result of merchandise search processing includes any items of merchandise information that do not contain a word “ [symbol] ” (meaning “meat and vegetable dumplings”, in Kanji) in a product name (Block 2003). In a case where the result of the determination executed at Block 2003 indicates that there are no items of merchandise information that do not contain the word “ [symbol] ” (meaning “meat and vegetable dumplings”, in Kanji) in the product name (NO of Block 2003), then the word-pronunciation connecting list distribution server 20 determines that a possibility that the word “ [symbol] ” (meaning “meat and vegetable dumplings”, in Kanji) is a typical notation is low, returns to processing of Block 2002, extracts from the search word list a word similar in sound or pronunciation to the word “ [symbol] ” (/gyōza/, meaning “meat and vegetable dumplings”, in Kanji), and performs merchandise search processing again using the extracted word as a search word. When there is no items of merchandise information, in each of which a product name does not contain the newly extracted search word, in merchandise information including at least one item of merchandise information and acquired by merchandise search processing executed for every search word, each search word is registered with a word-pronunciation connecting list as a typical notation.

In contrast, when there is an item of merchandise information that does not contain the word “ [symbol] ” (meaning “meat and vegetable dumplings”, in Kanji) in the product name as a result of the determination of Block 2003 (YES of Block 2003), the word-pronunciation connecting list distribution server 20 extracts from the merchandise information a word that is identical to “ [symbol] ” (/gyōza/, meaning “meat and vegetable dumplings”, in Kanji) in sound or similar in pronunciation (Block 2004). For example, when the merchandise information A1-A3 illustrated in FIG. 2 is acquired as a result of merchandise search processing at Block 2002, the word-pronunciation connecting list distribution server 20 extracts from two items of merchandise information A1 and A2 the words “ [symbol] ” (/gyōza/, meaning “meat and vegetable dumplings”, in Hiragana) and “ [symbol] ” (/gyōza/, meaning “meat and vegetable dumplings”, in Katakana) each as a word that is identical to “ [symbol] ” (/gyōza/, meaning “meat and vegetable dumplings”, in Kanji) in sound or similar in pronunciation.

Then, the word-pronunciation connecting list distribution server 20 performs merchandise search processing using as a search word each of the words “ [symbol] [symbol] ” (meaning “meat and vegetable dumplings”, in Hiragana) and “ [symbol] ” (meaning “meat and vegetable dumplings”, in Katakana) having been extracted by the process of Block 2004. And so, it determines whether or not the merchandise information acquired as a result of the merchandise search processing includes any items of merchandise information that do not contain the search word in the respective product names. Namely, when merchandise search processing is performed using the word “ [symbol] ” (meaning “meat and vegetable dumplings”, in Hiragana) as a search word, it determines whether there is an item of merchandise information that does not contain the word “ [symbol] ” (in Hiragana) in a product name, and when merchandise search processing is performed using the word “ [symbol] ” (meaning “meat and vegetable dumplings”, in Katakana) as a search word, it determines whether or not there is an item of merchandise information that does not contain the word “ [symbol] ” (in Katakana) in a product name (Block 2005).

When it is determined as a result of the determination process executed at Block 2005 that there is no item of merchandise information that does not contain a search word in a product name (NO of Block 2005), the word-pronunciation connecting list distribution server 20 generates an alias list by registering the word used as a search word at the time of processing at Block 2002 as the typical notation, and the word extracted at the time of processing at Block 2004 as an additional notation related to the typical notation (Block 2006). Specifically, the word-pronunciation connecting list distribution server 20 performs merchandise search processing using the word “ [symbol] ” (meaning “meat and vegetable dumplings”, in Kanji) as a search word. In such case, it obtains not only items of merchandise information, each containing the word “ [symbol] ” (in Kanji) in its product name, but also further items of merchandise information containing in their individual product names the word “ [symbol] ” (meaning “meat and vegetable dumplings”, in Hiragana) or “ [symbol] ” (meaning “meat and vegetable dumplings”, in Katakana) as a result of merchandise search processing. In contrast, when merchandise search processing is performed using the word “ [symbol] ” (meaning “meat and vegetable dumplings”, in Hiragana) or “ [symbol] ” (meaning “meat and vegetable dumplings”, in Katakana) as a search word, any item of merchandise information which does not contain in its product name neither of the search words but contains another word such as “ [symbol] (meaning “meat and vegetable dumplings”, in Kanji),” for example, will not be obtained as a result of merchandise search processing. Therefore, the word-pronunciation connecting list distribution server 20 generates an alias list by registering the word “ [symbol] ” (in Kanji) as a typical notation and the rest words “ [symbol] ” (in Hiragana) and “ [symbol] ” (in Katakana) as extra words.

On the other hand, when it is determined that there is item of merchandise information that does not contain a search word in a product name as a result of the determination executed at Block 2005 (YES of Block 2005), the word-pronunciation connecting list distribution server 20 compares the number of items of merchandise information acquired as a result of the merchandise search processing performed at Block 2002 with the number of items of the merchandise information acquired as a result of the merchandise search processing performed at Block 2004, and registers as a typical notation a search word which acquires the largest number of merchandise information items and the other search words as additional notations (Block 2007). Specifically, the word-pronunciation connecting list distribution server 20 compares the number of merchandise information items acquired as a result of merchandise search processing using the words “ [symbol] ” (in Kanji) “ [symbol] ,” (in Hiragana) and “ [symbol] ,” (in Katakana) (meaning “meat and vegetable dumplings”) as search words, and generates an alias list or an additional notation list by registering as a typical notation a search word which acquires the largest number of merchandise information items whereas the other search words as additional notations.

As has been explained above, the second embodiment has such a construction as to generate an alias list even when the net shopping server 10 does not have an alias list or an alias list cannot be obtained from the net shopping server 10. Therefore, it is possible that the second embodiment achieves the same effect as the first embodiment does.

It should be noted that the operational procedures of each of the embodiments can be reduced to a computer program, which makes it possible to easily accomplish the same effects as each of the embodiments only to install the computer program in a computer through a computer readable storage medium storing the computer program and to cause the computer to execute the installed computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising a first server, a second server, and an electronic device communicably connected to one another,
the first server comprising:
a first storage storing a database containing at least a plurality of names, and
a second storage storing a first list comprising a plurality of notations of words, each of which is associated with at least one additional notation;
the second server comprising:
a third storage storing a second list generated based on the database and the first list, the second list associating the plurality of notations of words of the first list with a corresponding pronunciation; and
the electronic device comprising:
one or more processor configured to:
receive voice data,
identify a notation in the second list associated with a pronunciation obtained as a result of recognition processing applied to the received voice data,
present a user with the identified notation as a search word,
search the database for a first name including the presented search word, and
present the user with the search result.

2. The system of claim 1, wherein the processor is further configured to search the database for a second name along with the first name with reference to the first list, the second name including any one of the at least one additional notation related to the notation presented as the search word.

3. The system of claim 1, wherein the first list indicates an association of each word between the notation of the word and at least one additional notation, the at least one additional notation being equivalent in meaning and in pronunciation to the notation or equivalent in meaning and similar to a threshold degree in pronunciation to the notation.

4. The system of claim 1, wherein the first list is generated by: using a first word to search the database for a name containing the first word, and identifying the notation and at least one additional notation associated with the notation based on a result of the search.

5. A server communicable with an electronic device capable of searching a database including a plurality of names for a first name containing a first word, the server comprising:
a storage storing a first list comprising a plurality of notations of words, each of which is associated with a corresponding pronunciation;
a transmitter configured to transmit the first list to the electronic device to prevent the electronic device from presenting to a user one or more additional notations as search words in addition to the notation, the additional notations being equivalent in meaning and in pronunciation to the notation or equivalent in meaning and similar to a threshold degree in pronunciation to the notation.

6. The server of claim 5, further comprising a generator configured to use the first word as the search word to search the database for the first name comprising the first word and to generate using a result of the search of s second list indicative of an association between the notation of the first word and at least one additional notation of the first word different from the notation.

7. An electronic device communicable with a first server and a second server, wherein
the first server comprises:
a first storage storing a database containing at least a plurality of names; and
a second storage storing a first list comprising a plurality of notations of words, each of which is associated with at least one additional notation, and
the second server comprises:
a third storage storing a second list generated based on the database and the first list, the second list associating with the plurality of notations of words of the first list with a corresponding pronunciation,
the electronic device comprising:
one or more processor configured to:
receive voice data;
identify a notation in the second list associated with a pronunciation obtained as a result of recognition processing applied to the received voice data;
present the identified notation to a user as a search word;
search the database for a first name containing the presented search word; and
present the search result to the user.

8. The electronic device of claim 7, wherein the processor is further configured to search the database for the second name along with the first name based on the first list, the second name including an additional notation related to the notation presented as the search word.

9. The electronic device of claim 7, wherein the first list indicates an association of each word between the notation of the word and at least one additional notation, the at least one additional notation being equivalent in meaning and in pronunciation to the notation or equivalent in meaning and similar to a threshold degree in pronunciation to the typical notation.
